(19) United States
(12) Patent Application Publication
(10) Pub. No.: US 2024/0177439 A1
(43) Pub. Date: May 30, 2024

(54) INFORMATION PROCESSING SYSTEM, INFORMATION PROCESSING METHOD, AND PROGRAM

(71) Applicant: GREE, Inc., Tokyo (JP)

(72) Inventor: Akihiko SHIRAI, Kanagawa (JP)

(73) Assignee: GREE, Inc., Tokyo (JP)

(21) Appl. No.: 18/216,619

(22) Filed: Jun. 30, 2023

Related U.S. Application Data
(60) Provisional application No. 63/428,203, filed on Nov. 28, 2022.

(30) Foreign Application Priority Data
Mar. 31, 2023 (JP) 2023-057030

(51) Int. Cl. G06T 19/20; G06T 15/04

(52) U.S. Cl. CPC G06T 19/20; G06T 15/04; G06T 2219/2012; G06T 2219/2021; G06T 2219/2024

(57) ABSTRACT

An information processing system includes processing circuitry configured to acquire an input given by a user; acquire, using a machine learning model constructed by artificial intelligence, a specific image obtained by inputting the given input to the first machine learning model; and associate the specific image with a specific item usable in a virtual space.

### CROSS-REFERENCE TO RELATED APPLICATIONS

This application claims priority to U.S. Provisional Application No. 63/428,203, filed Nov. 28, 2022, and to Japanese Application No. 2023-057030, filed Mar. 31, 2023, the entire contents of each of which is incorporated by reference.

### BACKGROUND

### 1. Technical Field

The present disclosure relates to an information processing system, an information processing method, and a program.

### 2. Description of the Related Art

A technique for adding an image suitable for an input document is known in relation to Word2Image. Further information related to the art will be found, for example, in Japanese Unexamined Patent Application Publication No. 2011-221794.

### SUMMARY

In an aspect, the present disclosure provides an information processing system including processing circuitry configured to acquire an input given by a user; acquire, using a machine learning model constructed by artificial intelligence, a specific image obtained by inputting the given input to the first machine learning model; and associate the specific image with a specific item usable in a virtual space.

### BRIEF DESCRIPTION OF THE DRAWINGS

FIG. 1 is a block diagram of a system according to an embodiment;

FIG. 2 is a block diagram of a processing circuit configured to perform a computer-based operation in accordance with the present disclosure;

FIG. 3 is a flowchart illustrating an outline of an example of a flow of a process performed in the system;

FIGS. 4A and 4B are diagrams for use in illustrating the process shown in FIG. 3 and a concept of mixing in a semantic space;

FIG. 5 is a diagram for explaining the process shown in FIG. 3 in relation to a specific image;

FIG. 6 is a diagram for explaining the process shown in FIG. 3 in relation to an avatar and items worn by the avatar;

FIG. 7 is a diagram for explaining the process shown in FIG. 3 in relation to items that can be placed in a virtual space;

FIG. 8 is a diagram for explaining the process shown in FIG. 3 in relation to an avatar and a combination of pieces of furniture in a virtual space;

FIG. 9 is a flowchart illustrating an outline of another example of a flow of a process performed in the system;

FIGS. 10A and 10B are diagrams for explaining the process shown in FIG. 9 in relation to a difference between item textures;

FIG. 11 is a flowchart illustrating an outline of another example of a flow of a process performed in the system;

FIG. 12 is a diagram for explaining the process shown in FIG. 9 in relation to shapes of items that can be worn by an avatar;

FIG. 13A is a diagram illustrating an example of a UI usable to generate/input input information, instruct mixing of a plurality of specific images, and/or the like;

FIG. 13B is a diagram illustrating an example of a UI usable to adjust a color;

FIG. 13C is a diagram illustrating an example of a UI usable to select an item;

FIGS. 14A and 14B are diagrams illustrating item elements that can be managed for each paper pattern or for each part;

FIG. 15 is a diagram schematically illustrating an example of a manipulator in a metaverse space;

FIG. 16 is a flowchart showing an example of an outline of a user-side operation procedure for the system;

FIG. 17 is a diagram for explaining the procedure described in FIG. 16 regarding a manner in which a user edits clothes (dress) worn by an avatar displayed on a screen;

FIG. 18 is a flowchart showing a process performed by a server device in response to receiving a store review application;

FIG. 19 is a flowchart illustrating an outline of an example of a uniqueness evaluation process;

FIG. 20 is a block diagram schematically illustrating an example of a set of functions of a server device;

FIG. 21 is a diagram schematically illustrating a manner in which a simultaneous (batch) reflection is performed on a plurality of specific items; and

FIG. 22 is a diagram conceptually illustrating a manner in which a contest is held.

### DETAILED DESCRIPTION

The inventor of the present disclosure has determined that it is difficult to apply a conventional technology to a specific item that can be used in a virtual space. The inventor has developed technology as described in the present disclosure to provide a technique for applying an image generated by artificial intelligence (AI) to a specific item that can be used in a virtual space.

In an aspect, the present disclosure provides an information processing system including a user input acquisition unit configured to acquire an input given by a user, an image acquisition unit configured to acquire, using a first machine learning model constructed by artificial intelligence, a specific image obtained by inputting the given input to the first machine learning model, and an association processing unit configured to associate the specific image with a specific item usable in a virtual space.

In an aspect, it is possible to associate a suitable image or the like with a specific item available in the virtual space.

Embodiments are described in detail below with reference to the accompanying drawings. Note that in some of the accompanying drawings, for ease of viewing, reference numerals are given only to a part of a plurality of elements that are similar in attribute.

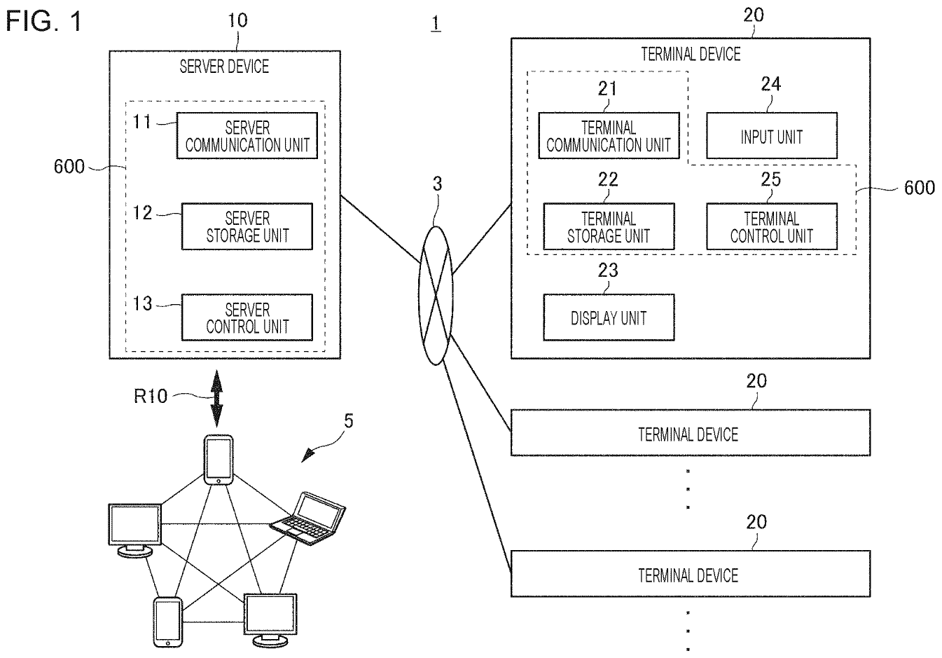

With reference to FIG. 1, an overview of a system 1 according to an embodiment is described. FIG. 1 is a block diagram of the system 1 according to the embodiment.

The system 1 includes a server device 10 and one or more terminal devices 20. Although three terminal devices 20 are shown in FIG. 1 for simplicity, the number of terminal devices 20 may be different.

For example, the server device 10 is an information processing device such as a server managed by an operator who provides one or more content generation support services. The terminal device 20 is a device used by a user, such as a mobile phone, a smart phone, a tablet terminal, a personal computer (PC), a head-mounted display, or a gaming device. A plurality of terminal devices 20 may be connected to the server device 10 via a network 3, typically in a different manner for each user.

The terminal device 20 can execute the content generation support application according to the present embodiment. The content generation support application may be received by the terminal device 20 from the server device 10 or a predetermined application distribution server via the network 3, or the content generation support application may be stored in advance in a storage device provided in the terminal device 20 or storage medium such as a memory card or the like readable by the terminal device 20. The server device 10 and the terminal device 20 are connected via the network 3 such that they can communicate with each other. For example, the server device 10 and the terminal device 20 cooperate to execute various processes related to the content generation support.

The network 3 may include a wireless communications network, the Internet, a virtual private network (VPN), a wide area network (WAN), a wired network, or any combination of these.

In the present embodiment, the server device 10 may be connected to a blockchain network 5 (see an arrow R10). The blockchain network 5 is a network in which a large number of computers are connected to each other, and each connected computer serves as a node to store a processing request that is sent from the server device 10 to the blockchain network 5, and each computer executes processing according to the processing request from a user and stores the result in a storage managed by the node. The processing request is transmitted to each node, and each node executes the same processing according to the processing request and stores the result such that each node holds exactly the same information even in a distributed environment. The processing executed on the blockchain is also referred to as a smart contract. A part or all of the nodes of the blockchain network 5 may be realized by the terminal devices 20, and a part or all of the network related to the blockchain network 5 may be realized by the network 3.

In the following description, it is assumed that the system 1 realizes an example of an information processing system, but an example of an information processing system may be realized by elements (such as a terminal communication unit 21, a terminal storage unit 22, and a terminal control unit 25 shown in FIG. 1) of a specific terminal device 20. Alternatively, an example of an information processing system may be realized by a cooperation of a plurality of terminal devices 20. The server device 10 may solely realize an example of an information processing system, or the server device 10 and one or more terminal devices 20 may cooperate to realize an example of an information processing system.

### Configuration of Server Device

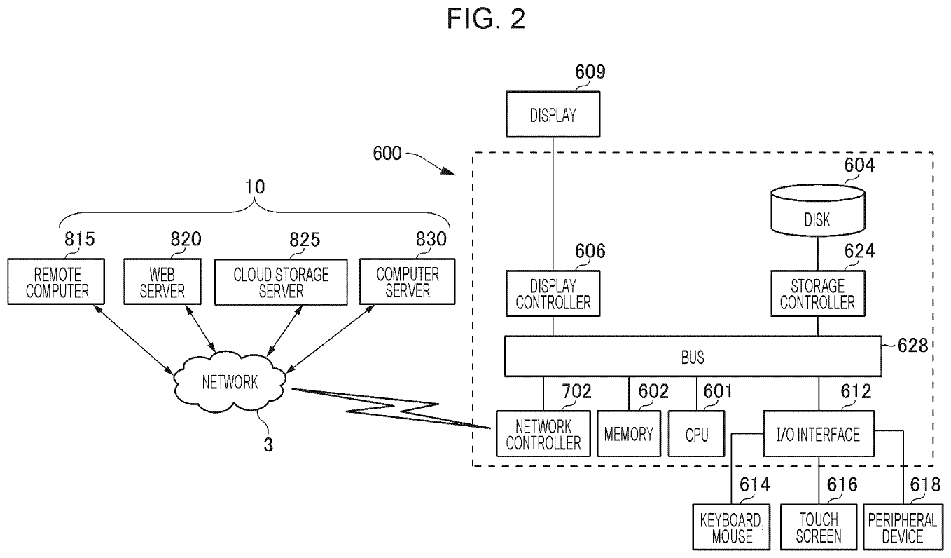

A specific example of a configuration of the server device 10 is described below. The server device 10 is configured by a server computer. The server device 10 may be realized in cooperation with a plurality of server computers. For example, the server device 10 may be realized in cooperation with a plurality of server computers that provide various contents and/or by a plurality of server computers that implement various authentication server devices. The server device 10 may include a web server 820 (see FIG. 2). In this case, a part of the functions of the terminal device 20, which will be described later, may be realized by a browser processing an HTML document received from the web server 820 (see FIG. 2) and various programs (JavaScript®) attached thereto.

The server device 10 includes a server communication unit 11, a server storage unit 12, and a server control unit 13, as shown in FIG. 1.

The server communication unit 11 includes an interface (see an I/O interface 612, a network controller 702, etc. shown in FIG. 2) configured to communicate with an external device wirelessly or by wire to transmit/receive information. The server communication unit 11 may include, for example, a wireless LAN (Local Area Network) communication module or a wired LAN communication module. The server communication unit 11 can transmit and receive information to and from the terminal device 20 via the network 3.

The server storage unit 12 is, for example, a storage device configured to store various kinds of information and programs necessary for various processes related to the content generation support.

The server control unit 13 may include a dedicated microprocessor, or a CPU (Central Processing Unit) or a GPU (Graphics Processing Unit) or the like configured to realize a specific function by reading a specific program (see CPU 601 in FIG. 2). For example, the server control unit 13 cooperates with the terminal device 20 to execute a content generation support application according to a user's operation on a display unit 23 (a touch panel) of the terminal device 20.

### Configuration of Terminal Device

A configuration of the terminal device 20 is described below. As shown in FIG. 1, the terminal device 20 includes a terminal communication unit 21, a terminal storage unit 22, a display unit 23, an input unit 24, and a terminal control unit 25.

The terminal communication unit 21 includes an interface (see the I/O interface 612, the network controller 702, etc. shown in FIG. 2) configured to communicate with an external device wirelessly or by wire to transmit/receive information. The terminal communication unit 21 may include a wireless communication module according to a mobile communication standard such as LTE (Long Term Evolution®), LTE-A (LTE-Advanced), fifth generation mobile communication system, UMB (Ultra Mobile Broadband), etc., a wireless LAN communication module, a wired LAN communication module, and/or the like. The terminal communication unit 21 is capable of transmitting and receiving information to and from the server device 10 via the network 3.

The terminal storage unit 22 includes, for example, a primary storage device and a secondary storage device. More specifically, for example, the terminal storage unit 22 may include a semiconductor memory, a magnetic memory, an optical memory, and/or the like. The terminal storage unit 22 stores various kinds of information and programs related to the content generation support received from the server device 10. Part or all of the information and programs related to the content generation support may be acquired from an external device via the terminal communication unit 21. For example, a content generation support application program may be acquired from a specific application distribution server. Hereinafter, the application program is also referred to simply as the application.

The display unit 23 includes a display device such as a liquid crystal display or an organic EL (Electro-Luminescence) display (see also the display 609 in FIG. 2). The display unit 23 is capable of displaying various images. The display unit 23 includes, for example, a touch panel and functions as an interface that detects various user operations. Note that the display unit 23 may be built in a head-mounted display as described above.

The input unit 24 may include a physical key, and may further include an input interface such as a pointing device, a mouse or the like. The input unit 24 may be capable of accepting non-contact user input such as a voice input, a gesture input, a line-of-sight input, or the like. The gesture input may be accepted by a sensor (an image sensor, an acceleration sensor, a distance sensor, etc.) configured to detect various states of the user, a dedicated motion capture system that integrates sensor technology and a camera, and a controller such as a joypad. The line-of-sight detection camera may be disposed in the head-mounted display. As described above, the various states of the user include the user's orientation, position, movement, and the like. The user's orientation, position, and movement encompass not only the orientation, position, and movement of user's hands or body but also encompass the orientation, position, and movement of a user's line of sight and/or the like.

The terminal control unit 25 includes one or more processors. The terminal control unit 25 controls the operation of the entire terminal device 20.

The terminal control unit 25 transmits and receives information via the terminal communication unit 21. For example, the terminal control unit 25 receives various kinds of information and programs related to the content generation support from at least one of the server device 10 and another external server. The terminal control unit 25 stores the received information and programs in the terminal storage unit 22. For example, the terminal storage unit 22 may store a browser (an Internet browser) for connecting to a web server 820 (see FIG. 2).

The terminal control unit 25 starts the content generation support application in response to a user's operation. The terminal control unit 25 cooperates with the server device 10 to execute processing related to the content generation support. For example, the terminal control unit 25 may perform control such that a GUI (Graphic User Interface) for detecting a user operation is displayed on a screen of the display unit 23. The terminal control unit 25 is capable of detecting a user operation via the input unit 24. For example, the terminal control unit 25 is capable of detecting various gesture operations by the user (such as operations corresponding to a tap operation, a long tap operation, a flick operation, a swipe operation, etc.). The terminal control unit 25 may transmit operation information to the server device 10.

FIG. 2 is a block diagram of a processing circuit 600 configured to perform a computer-based operation according to the present disclosure. The processing circuit 600 described below is suitable as a hardware configuration for realizing the server communication unit 11, the server storage unit 12, and the server control unit 13 of the server device 10 shown in FIG. 1. The processing circuit 600 described below is also suitable as a hardware configuration for realizing the terminal communication unit 21, the terminal storage unit 22, and the terminal control unit 25 of the terminal device 20 shown in FIG. 1.

The processing circuit 600 is used to control a computer-based or cloud-based control process. A description or a block in a flowchart can be understood as representing a module, a segment, or a portion of code that includes one or more executable instructions to implement a specific logical function or a step within a process. Note that various alternative implementations can be possible as understood by those skilled in the art by, for example, executing processing steps in a reverse order or an order different from the order disclosed in any embodiment or by executing steps in parallel according to related functions. Any such alternative implementation falls within the scope of the present disclosure. The function of each element disclosed herein may be realized using a general-purpose processor, a special purpose processor, an integrated circuit, an application specific integrated circuit (ASIC), a conventional circuit, and/or a circuit or a processing circuit that may include a combination of the above, that are configured or programmed to perform the above-described function. The processor includes transistors and other circuits therein and thus the processor is a kind of processing circuit, circuit or processing circuitry. The processor may be a processor programmed to execute a program stored in the memory 602. In the present disclosure, processing circuits, processing circuitry units, and means are each hardware that performs, or is programmed to perform, one or more of the functions described above. The hardware may be any hardware, disclosed herein or otherwise known, that is programmed or configured to perform the specified functions.

In the processing circuit 600 shown in FIG. 2, a display controller 606, a storage controller 624, a network controller 702, a memory 602, an I/O interface 612, etc., are connected to each other via a bus 628. The processing circuit 600 is connected to the display 609 via the display controller 606 and to a keyboard and a mouse 614, a touch screen 616, and a peripheral device 618 via the I/O interface 612. The processing circuit 600 is capable of accessing the network 3 via the network controller 702. The display 609 and the display controller 606 may be connected to each other via a standard connection method according to a video transfer standard such as VGA, DVI, DisplayPort, HDMI, or the like.

In FIG. 2, the processing circuit 600 includes a CPU 601 that executes one or more of the control processes discussed in the present disclosure. Processing data and instructions may be stored in the memory 602. Alternatively, these processing data and instructions may be stored in a storage medium disk 604 (denoted as “disk” in FIG. 2) such as a hard disk drive (HDD) or a portable storage medium, or stored remotely. Note that the progressive features described in the claims are not limited by the form of the computer-readable medium in which the instructions according to the present disclosure are stored. For example, the instructions may be stored in one of the following computer-readable storage media: a CD, a DVD, a FLASH® memory, a RAM, a ROM, a PROM, an EPROM, an EEPROM, and a hard disk. Note that the storage media are not limited to those described above, and the instructions may be stored in any other type of non-transitory computer-readable storage medium. Still note that these computer-readable storage media may be located in an information processing device with which the processing circuit 600 communicates, such as a server or a computer. Instructions and/or data related to processes may be stored in a network-based storage, a cloud-based storage, or other mobile-accessible storage such that the processes are executable by the processing circuit 600.

The progressive features described in the claims may be provided by a utility application, a background daemon, or a component of an operating system, or a combination of any of these, which may be executed by the CPU 601 in cooperation with an operating system such as Microsoft Windows®, UNIX®, Solaris®, LINUX®, Apple®, MAC-OS®, Apple iOS®, or any other operating system known to those skilled in the art.

Part or all of hardware elements of the processing circuit 600 may be realized by various circuit elements. Each function of the above-described embodiments may be realized by processing circuitry including one or more processing circuits. The processing circuit may include a specifically programmed processor, such as the processor (CPU) 601 shown in FIG. 2. The processing circuit may include a device such as an application specific integrated circuit (ASIC) or a conventional circuit component, configured to perform a specified function.

In FIG. 2, the processing circuit 600 may be a computer or a special purpose machine. The processing circuit 600 is programmed to execute processing for controlling a device (such as the server device 10 or the terminal device 20) on which the processing circuit 600 is installed.

Alternatively or additionally, the CPU 601 may be realized on an FPGA (Field Programmable Gate Array, an ASIC, or a PLD (Programmable Logic Device, or may be realized using discrete logic circuits, as will be appreciated by those skilled in the art. Still alternatively or additionally, the CPU 601 may be realized by a plurality of processors that operate in parallel and cooperatively to execute the instructions of various processes.

The processing circuit 600 shown in FIG. 2 also includes the network controller 702, such as an Ethernet PRO network interface card or the like, for interfacing with the network 3. As can be appreciated, the network 3 can be a public network such as the Internet, or a private network such as a local area network (LAN) or a wide area network (WAN), or any combination thereof. The network 3 may include a PSTN (Public Switched Telephone Network, an ISDN (Integrated Services Digital Network), or a sub-network. The network 3 may be a wired network 3 such as an Ethernet network, a USB (Universal Serial Bus) cable, or the like or a wireless network such as a cellular network, including EDGE, 3G, 4G and 5G wireless cellular systems. The wireless network may be a network based on Wi-Fi®, wireless LAN, Bluetooth®, or other forms of wireless communication known in the art. The network controller 702 may be a network controller complying with Bluetooth® or the near field communication (NFC) standard, or an infrared communication standard or co standard or complying with other direct communication standard.

FIG. 2 also shows an example of a configuration of the server device 10. In the example shown in FIG. 2, the server device 10 includes a remote computer 815, a web server 820, a cloud storage server 825, and a computer server 830. Details of the hardware configuration of the remote computer 815, the web server 820, the cloud storage server 825, and the computer server 830 are not described, but may be similar to those of the processing circuit 600.

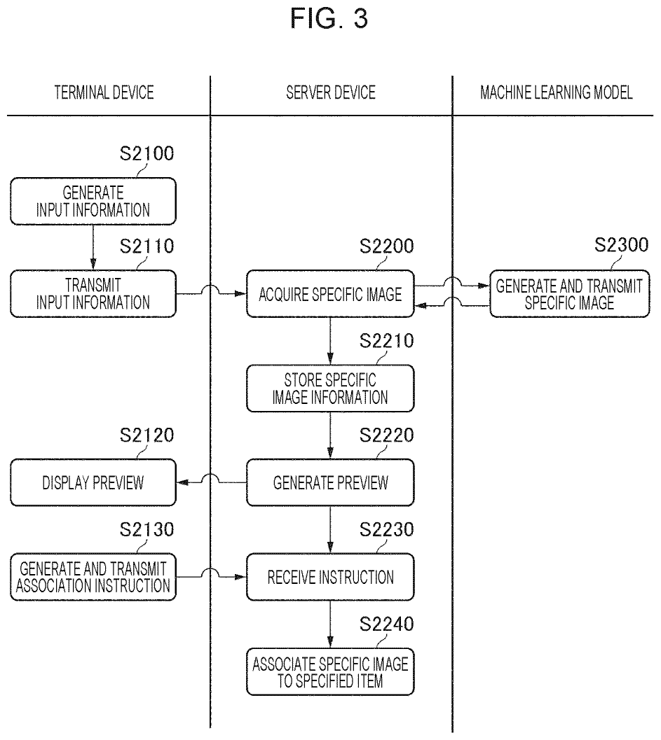

Further details of the system 1 are described below with reference to FIG. 3 and subsequent figures.

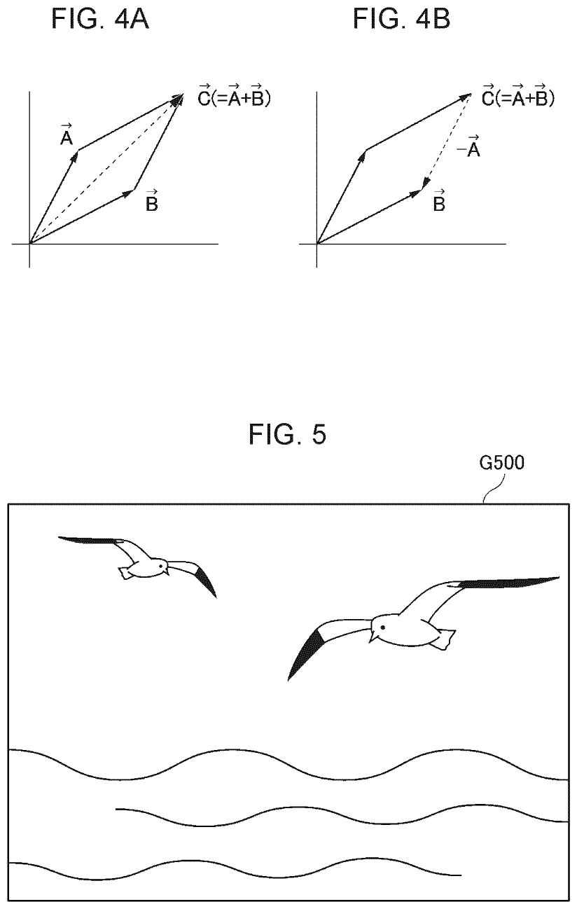

FIG. 3 is a flowchart illustrating an outline of an example of a flow of a process that may be performed in the system 1. FIGS. 4A and 4B and FIGS. 5 to 8 are diagrams for use in illustrating the process shown in FIG. 3.

In FIG. 3, the process is shown separately for the server device 10 and the terminal device 20. Although the process realized by the machine learning model (an example of the first machine learning model) is part of the processing performed by the server device 10, it is shown separately for convenience. Although one terminal device 20 will be described below in the following explanation, other terminal devices 20 can realize similar functions. Note that hereinafter, unless otherwise specified, “user” refers to a user of one terminal device 20.

The user generates input information (an example of a given input) via the terminal device 20 (in step S2100) and transmits it to the server device 10 (in step S2110). In the example shown in FIG. 3, the input information is information related to an image the user has in his/her mind. For example, when the user wants to obtain a desired image, the input information is information representing the desired image. The input information may include at least one of the following: a text, a symbol, a pictogram, a digit figure, a color, a texture, an image, a sound, a gesture (including motion), and a combination of any two or more of these. The text is typically a string of characters that have meaning, but may include a string of characters that have no meaning. The input information may be input in a template format. When the server device 10 acquires the input information, the server device 10 acquires a specific image obtained by inputting the input information into a predetermined machine learning model (in steps S2200 and S2300). The predetermined machine learning model is a machine learning model built by artificial intelligence to generate and output an image based on an input such as the input information described above. Hereinafter, for distinction, the machine learning model that generates and outputs an image based on input such as the above-described input information is also referred to as the “image output model”. The image output model may be constructed in any manner, but in a desirable example, the model is constructed to be capable of generating an image that reflects various contexts based on the input information. Latent Diffusion Models or a similar model may be used to build the image output model.

FIGS. 4A and 4B are diagrams illustrating an example of a method of generating input information, in which character strings are each represented by a vector, and vectors are added or subtracted in a meaning space. The method of generating the input information may include mixing concepts (meanings, contexts) given by two or more characters. For example, as conceptually shown in FIGS. 4A and 4B, the image output model may be built such that based on a character string A (for example, “bird”) and another character string B (for example, “sea”), an image of a character string C (for example, “seabird”) is generated. In this case, if it is allowed to perform synthesis not only by addition but also by subtraction between a plurality of character strings, it is possible to increase the probability that the user can obtain a desired specific image even when the user does not think of an appropriate character string. For example, the synthesis by the subtraction of the character string C and the character string B is equivalent to the input of the character string A. In the diffusion model described above, a directional component towards a desired string is embedded in the noise removal process, and thus the diffusion model has the advantage that even details that are difficult to express solely by the simple synthesis of strings can be visualized.

The specific image may be a still image or a moving image. The type, the size, and/or the like of the specific image may be specified by information separate from the input information, or may be included in the input information. FIG. 5 shows an example of an image (a specific image) G500 in which seagulls are flying over the sea. Such a specific image may be generated, for example, when the input information includes “bird” and “sea”.

It may be allowed that the input information includes a character string related to a so-called negative word. The negative word has a concept similar to the “subtraction” related to the synthesis of character strings described above, but is used to prevent the generated result from including an image related to the negative word. For example, in a case where the input information includes “birds” and “sea” and also includes “seagull” as a negative word, the specific image may be generated such that it does not include a seagull.

The server device 10 may determine whether or not the input information includes any one of predetermined prohibited words. If one of the predetermined prohibited words is included in the input information, the server device 10 may notify the terminal device 20 of this fact to request the user to regenerate the input information so as not to include any of the predetermined prohibited words and to retransmit the regenerated input information. The predetermined prohibited words may include words that are deemed to be in violation of public order or morality, such as obscene words, slanderous expressions, or hateful language, and words that infringe or are likely to infringe on the intellectual property rights of others. The predetermined prohibited words may be stored and accumulated in the server storage unit 12 or the like in the form of a dictionary.

Referring again to FIG. 3, when the server device 10 acquires the specific image, the server device 10 stores specific image information in the server storage unit 12 (in step S2210). The specific image information includes the image data of the specific image and the input information used to generate the specific image in a mutually associated form.

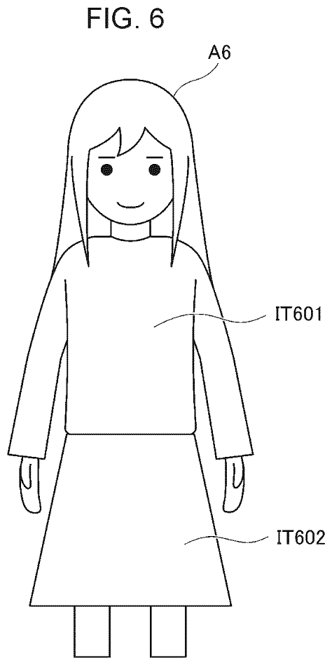

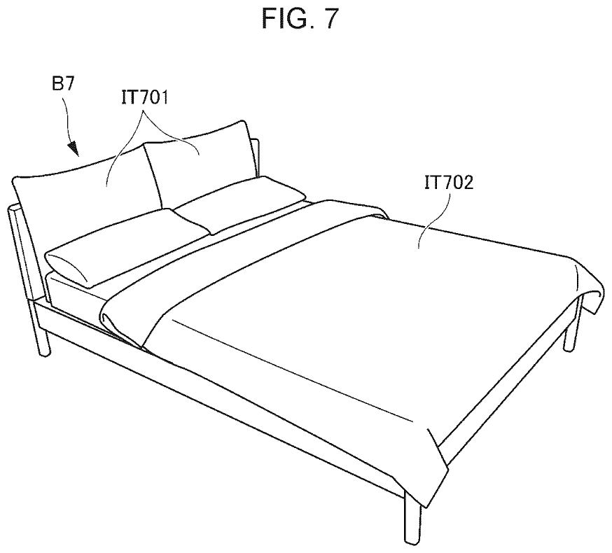

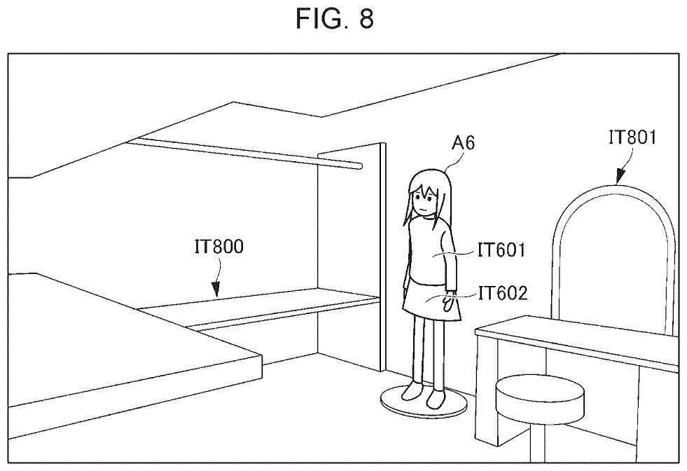

Next, the server device 10 generates a preview display of the specific image (in step S2220) and enables the preview display to be output on the terminal device 20. The user can determine whether a correction, a modification, or the like is needed for the specific image while viewing the preview display on the terminal device 20 (in step S2120). Note that the preview display may be the specific image itself, or may be realized as a display reflected on any item available in a virtual space (for example, an item specified by the user). In the latter case, the item may be an item that can be associated with an avatar in the virtual space (for example, clothes 601 and 602 of an avatar A6 shown in FIG. 6), or an item that can be placed in the virtual space (for example, entire furniture B7 or its constituent element IT701 or IT702 shown in FIG. 7), or any combination thereof (for example, a combination of an avatar and furniture in the virtual space shown in FIG. 8). In this case, the preview display may be a three-dimensional display, and may be allowed to be panned and/or rotated like a CAD (Computer Aided Design) viewer. For example, in a case where the item is clothes of the user's avatar, an avatar wearing clothes that reflect the specific image may be generated, and the clothes and the avatar may be previewed together.

In a case where the user determines that there is no need for correction or the like for the specific image generated in the manner described above, a final version of an association instruction is generated to associate the specific image with an item available in the virtual space (for example, an item specified by the user), and the generated instruction is transmitted to the server device 10 (in step S2130). The association instruction may include information that identifies the item to be associated.

Upon receiving the association instruction (in step S2230), the server device 10 associates the specific image with the specific item specified to be associated with the specific image (in step S2240). For example, in a case where the specific item is clothes of the user's avatar, the association of the specific image may be realized by causing part or all of the clothes to include the specific image. Such a reflection method may be specified by information different from the input information, or may be specified in the input information.

By performing the process shown in FIG. 3 as described above, the user can obtain a specific image by generating input information corresponding to an image the user has in his/her mind, without the user having to draw the image, and the specific image can be reflected on an item available in the virtual space. By using the specific image as a base image, it also becomes possible to generate a new design in a region (for example, a region in the virtual space).

In the process shown in FIG. 3, in a case where the item to be associated is determined in advance, the input information generated in step S2100 may include the attribute and the name of the item to be associated (that is, the specific item). In this case, it may become possible to obtain a specific image taking into account the attribute or the like of the specific item. In a case where the preview display is unnecessary, the input information including the association instruction given in step S2130 may be collectively transmitted to the server device 10.

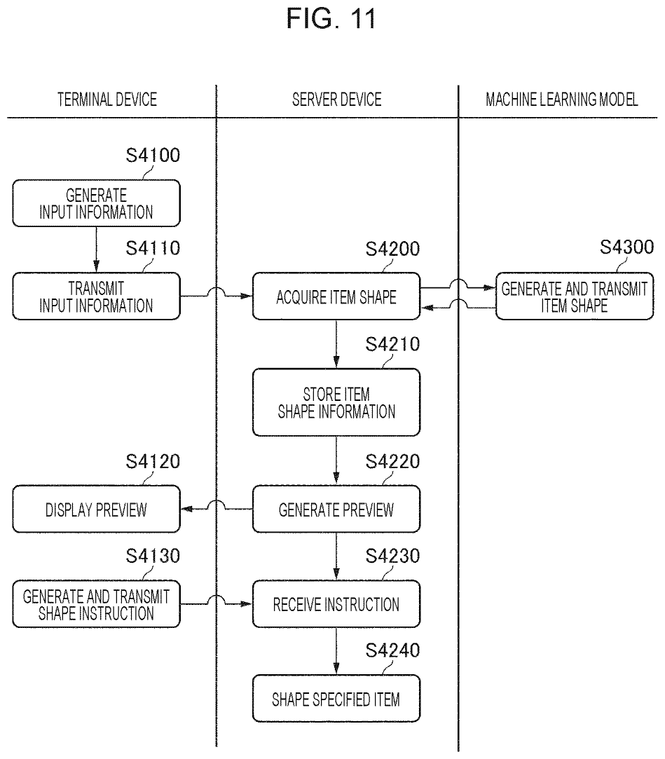

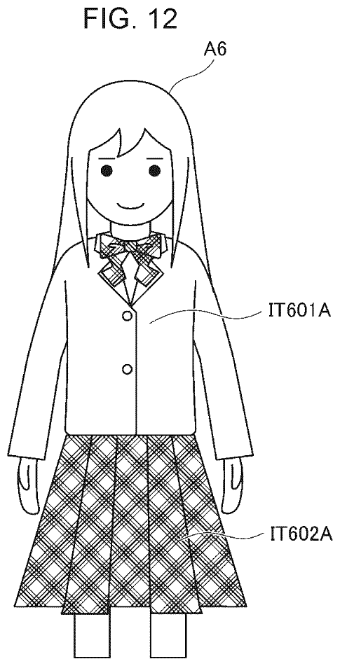

FIG. 11 is a flowchart illustrating an outline of another example of a flow of a process that may be executed in the system 1. FIG. 12 is a diagram for use in illustrating the process shown in FIG. 11.

In FIG. 11, the process is shown separately for the server device 10 and the terminal device 20. As in FIG. 3, the process realized by the machine learning model (an example of the second machine learning model) is part of the processing performed by the server device 10, but it is shown separately for convenience.

The user generates input information via the terminal device 20 (in step S4100) and transmits it to the server device 10 (in step S4110). In the example shown in FIG. 11, the input information is information related to an item shape the user has in his/her mind. For example, when the user wants to obtain a desired item shape, the input information is information representing this desired item shape. The input information may include at least one of the following: a text, a symbol, a pictogram, a digit figure, a color, a texture, an image, a sound, a gesture (including motion), and a combination of any two or more of these. The text is typically a string of characters that have meaning, but may include a string of characters that have no meaning. The input information may be input in a template format.

When the server device 10 acquires the input information, the server device 10 acquires an item shape obtained by inputting the input information into a predetermined machine learning model (in steps S4200 and S4300). The predetermined machine learning model is a machine learning model built by artificial intelligence such that it generates and outputs an item shape based on an input such as the input information described above. Hereinafter, for distinction, the predetermined machine learning model configured to generate and output an item shape based on an input such as the above-described input information is also referred to as the “item shape output model”. As for the item shape output model, a model different from the image output model described above may be used as an integrated model.

The method of generating the input information in this case may be similar to the method described above with reference to FIGS. 4A and 4B.

The item shape may be of any item available in the virtual space. The item shape may be a three-dimensional shape or a two-dimensional shape depending on the attribute of the item. For example, in a case where the item related to the item shape is clothes, the item shape may be given in the form of a paper pattern for clothes. When the item related to the item shape is a three-dimensional object, the item shape may be given in the form of a three-dimensional drawing, a three-dimensional form, or a combination of these. The type, the size, and/or the like of the item related to the item shape may be specified by information separate from the input information, or may be described in the input information.

The input information may be allowed to include a character string related to a so-called negative word. For example, in a case where the input information includes “car” and “sports” and includes “Germany” as a negative word, an item shape related to a sports car other than a German car may be generated.

The server device 10 may determine whether or not the input information includes any one of predetermined prohibited words, as with the case described above with reference to FIG. 3. If one of the predetermined prohibited words is included in the input information, the server device 10 may notify the terminal device 20 of this fact to request the user to regenerate the input information so as not to include any predetermined prohibited word and to retransmit the regenerated input information. The predetermined prohibited words may include words that are deemed to be in violation of public order or morality, such as obscene words, slanderous expressions, or hateful language, and words that infringe or are likely to infringe on the intellectual property rights of others. The predetermined prohibited words may be stored and accumulated in the server storage unit 12 or the like in the form of a dictionary.

When the server device 10 acquires the item shape, the server device 10 stores item shape information in the server storage unit 12 (in step S4210). The item shape information includes item shape data and input information used to generate the item shape in a mutually associated form.

Next, the server device 10 generates a preview display of the item shape (in step S4220) and enables the preview display to be output on the terminal device 20. The user can determine whether a correction, a modification, or the like is needed for the item shape while viewing the preview display on the terminal device 20 (in step S4120). Note that the preview display may be of the item shape itself, or it may be realized by reflecting the item shape on an image (for example, the specific image described above). The preview display may be a three-dimensional display, and may be allowed to be panned and/or rotated. For example, in a case where the item shape is a shape of clothes of an avatar of the user, the item shape may be a two-dimensional shape such as a paper pattern, or a three-dimensional shape attached to the user's avatar. In any case, the preview display may be realized three-dimensionally. In this case, for example, as shown in FIG. 12, the item shape may be previewed together with an avatar A6 wearing items IT601A and IT602A of clothing reflecting the item shape.

When the user determines that there is no need to modify or correct the item shape generated in the manner described above, a final version of a shaping instruction is generated to shape an item (for example, a desired item specified by the user) available in the virtual space, and the generated shaping instruction is transmitted to the server device 10 (in step S4130). The shaping instruction may include information identifying the item (the specific item) to be shaped.

When the server device 10 receives the shaping instruction (in step S4230), the server device 10 shapes the specific item to be shaped (in step S4240). The shaping method may include, for example, in a case where the specific item is clothes of a user's avatar, the shaping may be realized by shaping the clothes such that part or all of the clothes includes the item shape. Such shaping may be performed so as to fit the size of the specific item. Such a reflection method may be specified by information different from the input information, or may be specified in the input information.

As described above, according to the process shown in FIG. 11, the user can obtain the item shape by generating the input information corresponding to the image shape the user has in his/her mind without having to draw the item shape by himself/herself, and the user can reflect the obtained item shape on an item available in the virtual space.

In the process shown in FIG. 11, in a case where the item to be associated is predetermined, the input information generated in step S4100 may include the attribute and/or the name of the item to be associated (that is, the specific item). In this case, it may become possible to obtain the item shape taking into account the attribute or the like of the specific item.

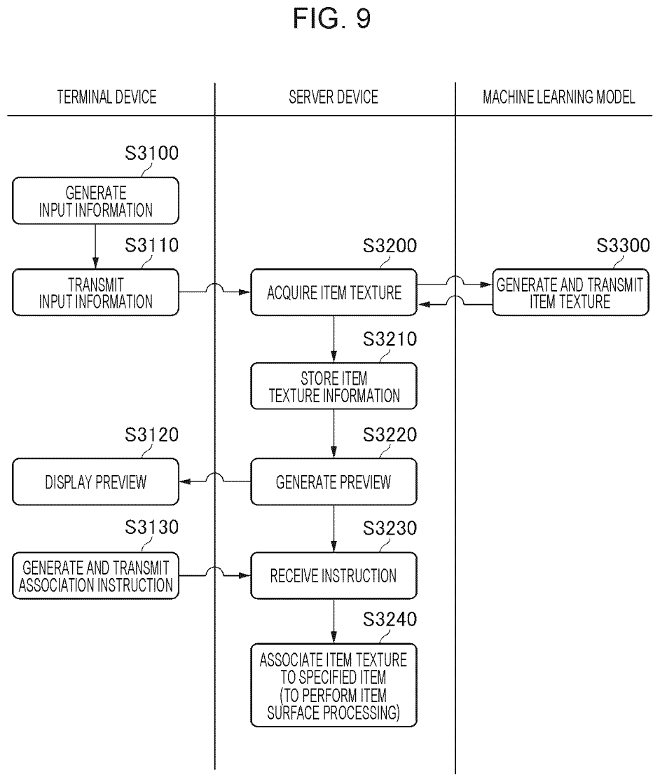

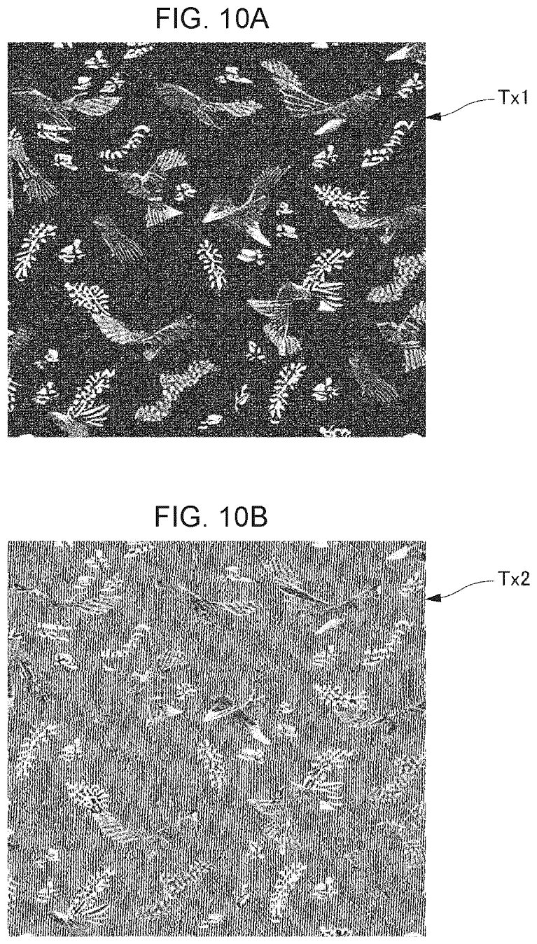

FIG. 9 is a flowchart illustrating an outline of another example of a flow of a process that may be executed in the system 1. FIGS. 10A and 10B are diagrams for use in illustrating the process shown in FIG. 9.

In FIG. 9, the process is shown separately for the server device 10 and the terminal device 20. As in FIG. 3, the process realized by the machine learning model (an example of the third machine learning model) is part of the processing performed by the server device 10, but it is shown separately for convenience.

The user generates input information via the terminal device 20 (in step S3100) and transmits it to the server device 10 (in step S3110). In the example shown in FIG. 9, the input information is information related to a texture of an item surface the user has in his/her mind. For example, when the user wants to obtain a desired texture, the input information is information representing this desired texture. The input information may include at least one of the following: a text, a symbol, a pictogram, a digit figure, a color, a texture, an image, a sound, a gesture (including motion), and a combination of any two or more of these. The text is typically a string of characters that have meaning, but may include a string of characters that have no meaning. The input information may be input in a template format.

When the server device 10 acquires the input information, the server device 10 acquires an item texture obtained by inputting the input information into a predetermined machine learning model (in steps S3200 and S3300). The predetermined machine learning model is a machine learning model built by artificial intelligence such that it generates and outputs a texture (an item texture) based on an input such as the input information described above. Hereinafter, for distinction, the predetermined machine learning model that generates and outputs the texture based on the input such as the above-described input information is also referred to as the “texture output model.” As for the texture output model, a model different from the image output model described above may be used as an integrated model.

The method of generating the input information in this case may be similar to the method described above with reference to FIGS. 4A and 4B.

The item texture may represent a surface texture of an item available in the virtual space. The grain size or the like of the item texture may be adjusted according to the attribute of the item such that the texture is visually recognizable. The type, the size, and/or the like of the item related to the texture may be specified by information separate from the input information, or may be included in the input information.

The item texture may be a simple plain texture, or may be a texture including a pattern or the like as shown in FIGS. 10A and 10B. In the latter case, the pattern may be a pattern for making the texture easily recognizable, or may be a pattern that can be used in combination with the texture. FIG. 10A shows an example of a texture Tx1 having relatively less unevenness on the surface, while an example of a texture Tx2 shown in FIG. 10B has relatively more unevenness on the surface.

The input information may be allowed to include a character string related to a so-called negative word. For example, in a case where the input information includes “outer wall” and “apartment” and includes “spraying” as a negative word, a texture related to the outer wall of the apartment other than the spraying may be generated (for example, a texture including bricks or tiles may be generated).

The server device 10 may determine whether or not the input information includes any one of predetermined prohibited words, as with the case described above with reference to FIG. 3. If one of the predetermined prohibited words is included in the input information, the server device 10 may notify the terminal device 20 of this fact to request the user to regenerate the input information so as not to include any predetermined prohibited word and to retransmit the regenerated input information. The predetermined prohibited words may include words that are deemed to be in violation of public order or morality, such as obscene words, slanderous expressions, or hateful language, and words that infringe or are likely to infringe on the intellectual property rights of others. The predetermined prohibited words may be stored and accumulated in the server storage unit 12 or the like in the form of a dictionary.

When the server device 10 acquires the item texture, the server device 10 stores item texture information in the server storage unit 12 (in step S3210). The item texture information includes item texture data and input information used to generate the item texture in a mutually associated form.

Next, the server device 10 generates a preview display of the item texture (in step S3220) and enables the preview display to be output on the terminal device 20. The user can determine whether a correction, a modification, or the like is needed for the item texture while viewing the preview display on the terminal device 20 (in step S3120). Note that the preview display may be of the item texture itself, or a result of reflecting the item texture onto an item. The preview display may be a three-dimensional display, and may be allowed to be panned and/or rotated. For example, in a case where the item of interest is clothes of the user's avatar, an avatar wearing the clothes on which the item texture is reflected may be generated, and the clothes and the avatar may be previewed together.

In a case where the user determines that there is no need for correction or the like for the item texture generated in the manner described above, a final version of an association instruction is generated to associate the item texture with an item (for example, a desired item specified by the user) available in the virtual space, and the generated instruction is transmitted to the server device 10 (in step S3130). The association instruction may include information identifying the item (the specific item) to which the item texture is to be associated.

When the server device 10 receives the association instruction (in step S3230), the server device 10 associates the item texture to the specific item to which the item texture is to be associated (step S3240). The association method may include, for example, in a case where the specific item is clothes of the user's avatar, the association may be realized by causing part or all of the clothes to include the item texture. The association described above may be performed so as to fit the size of the specific item. Such a reflection method may be specified by information different from the input information, or may be specified in the input information.

As described above, according to the process shown in FIG. 9, the user can obtain the desired item texture by generating the input information corresponding to the item texture user has in his/her mind without having to draw the item texture by himself/herself, and the user can reflect the obtained item texture on an item available in the virtual space.

In the process shown in FIG. 9, in a case where the item with which the item texture is to be associated is predetermined, the input information generated in step S3100 may include the attribute and/or the name of the item (the specific item) to which the item texture is to be applied. In this case, it may become possible to obtain an item texture taking into account the attribute or like of the specific item.

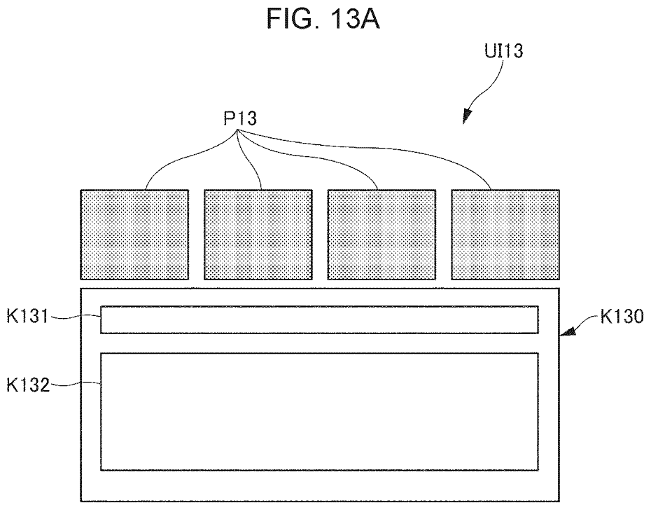

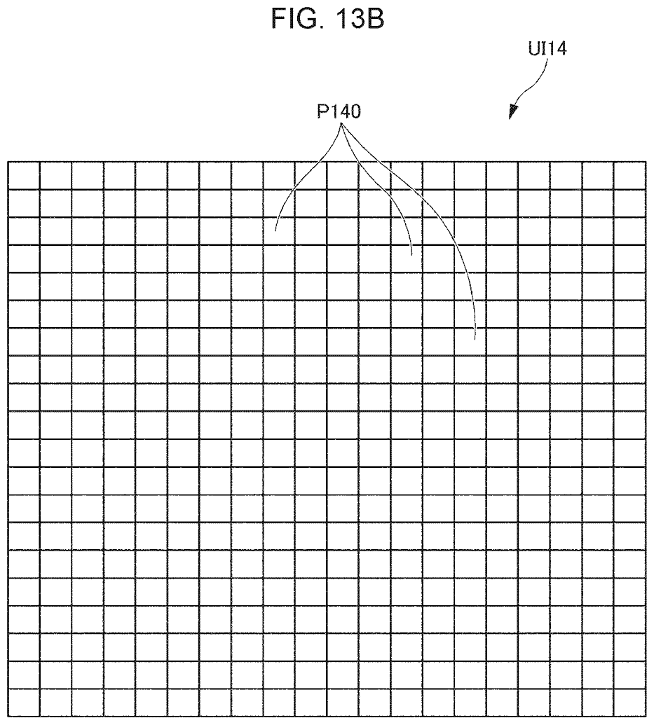

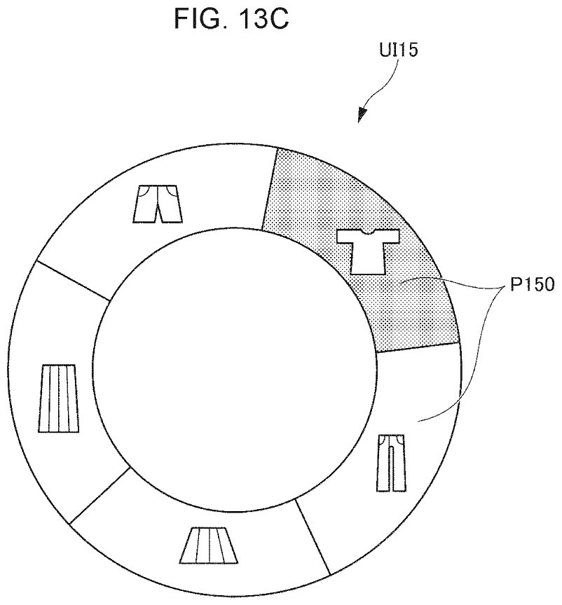

Next, user interfaces (UIs) suitable for the preview display described above are described with reference to FIGS. 13A to 13C. The UIs shown in FIGS. 13A to 13C may each be a UI available in virtual space and may be placed within the user's field of view.

FIG. 13A is a diagram illustrating an example of a UI 13 usable to generate/input input information, instruct mixing of a plurality of specific images, and the like.

In the example shown in FIG. 13A, the UI 13 includes four specific image display areas P13 and an input area K130. The input area K130 includes an input character output area K131 and a character input area K132. Each of the four specific image display areas P13 may be an area for outputting a specific image obtained by the method described above with reference to FIG. 3. Part or all of the four specific image display areas P13 may be capable of outputting, instead of or in addition to specific images obtained by the method described above with reference to FIG. 3, item textures obtained by the method described above with reference to FIG. 9 and/or item shapes obtained by the method described above with reference to FIG. 11.

The input character output area K131 may be an area for displaying various types of input information described above. The character input area K132 may be a UI for inputting the various types of input information described above. For example, the character input area K132 may be implemented as a keyboard. Note that the input of characters or the like to the input character output area K131 may be realized by other inputs such as a voice input. Input candidate words derived based on artificial intelligence or the like may be listed in the input character output area K131. For example, words suitable for input information, such as words for instructing patterns such as repeating patterns or seamless patterns, and words for instructing image operations such as image synthesis such as blending, etc., may be listed. This makes it possible for the user to enter desired characters without entering many characters. This is particularly suitable when the user wears a head-mounted display and stays in a metaverse space. This is because, in such an environment, unlike in a real world, it is often difficult to manually specify and input detailed information.

The UI 13 shown in FIG. 13A may be configured such that when the user selects desired one specific image display area P13 from the plurality of specific image display areas P13, a specific image or the like displayed in the selected one specific image display area P13 is selected. The selected specific image or the like may be reflected on the specific item as described above. When the user selects two or more from the specific images displayed in the plurality of specific image display areas P13, one of the following mixing or combining may be achieved for the selected specific images: mixing between specific images; mixing between item textures; combining of a specific image and an item texture; combining of a specific image and an item shape; combining of an item texture and an item shape; combining of a specific image, an item texture, and an item texture shape; etc. In this case, by combining various parameters, it becomes possible to easily form a desired item, which provides greater convenience to the user.

The UI 13 configured as described above is suitable for the preview display described above (see, for example, step S2120 in FIG. 3). For example, the user can fine-tune the specific image by operating the UI 13 on the preview display.

FIG. 13B is a diagram showing an example of a UI 14 for adjusting a color.

In the example shown in FIG. 13B, the UI 14 includes a plurality of sections (material color attributes) P140 representing a plurality of colors. Each of the plurality of sections P140 may be assigned a different color and colored with a corresponding color. In the example shown in FIG. 13B, 20×20 sections are arranged in the form of an array, but a larger number of sections may be provided. The setting of the colors of the plurality of sections P140 may be customized by the user, or the colors may be specified by variables whose value changes dynamically. The variables are not limited to RGB values but may include parameters indicating transparency and reflection or the like of materials. Alternatively, a color set determined in advance according to the item to be colored may be provided. Still alternatively, colors of the respective sections may be automatically set by AI or the like according to the item to be colored. The overall form of the UI 14 may change according to the item to be colored. For example, for coloring around the eyes of a face, the overall form of the UI 14 may be a cosmetic eyeshadow palette. Such a UI 14 may be automatically generated when an image including a base color set is given.

Using the UI 14 shown in FIG. 13B, the user can select a color associated with a desired section P140 by selecting this desired section P140 from the plurality of sections P140. In this case, the selected color may be reflected in some or all of the specific item, as described above.

The UI 14 configured as described above is suitable for the preview display described above (see, for example, step S2120 in FIG. 3). For example, by operating the UI 14 on the preview display, the user can adjust the color, hue, etc. of part or all of the specific image (or part or all of the specific item on which the specific image is reflected). In addition, other parameters such as the reflectance, roughness, material properties (for example, characteristics of the material of the item to be drawn), etc. may be adjustable. Note that the reflectance or the like may be adjustable as a texture.

FIG. 13C is a diagram showing an example of a UI 15 for selecting an item.

In the example shown in FIG. 13C, the UI 15 includes a plurality of sections P150 corresponding to different items. Different items or item parts (parts of an item) may be assigned to respective sections P150, and a schematic shape of the corresponding item may be indicated. In FIG. 13C, the number of sections P150 is five, and the overall shape of the UI is a ring. However, the number and shape may be different. The ring-shaped configuration such as that shown in FIG. 13C is advantageous compared to UIs using buttons or the like because, even when the number of items increases (for example, from five to eight), it can simply be adjusted by changing the angles of the sections while maintaining the shape of the ring without having to increase the number of UI elements such as buttons.

Using the UI 15 shown in FIG. 13C, the user can select a desired section P150 from the plurality of sections P150 thereby selecting an item or its part associated with the selected section P150. In this case, the selected item or its part may be editable by the UI 13 and/or the UI 14 as described above. Note that the items or parts thereof that can be selected in the plurality of sections P150 may be items or the like owned by the user.

The UI 15 configured as described above is suitable for the preview display described above for simultaneously editing a plurality of items (see, for example, step S2120 in FIG. 3). For example, the user can perform editing while selecting part or all items of the user's avatar by operating the UI 15 on the preview display.

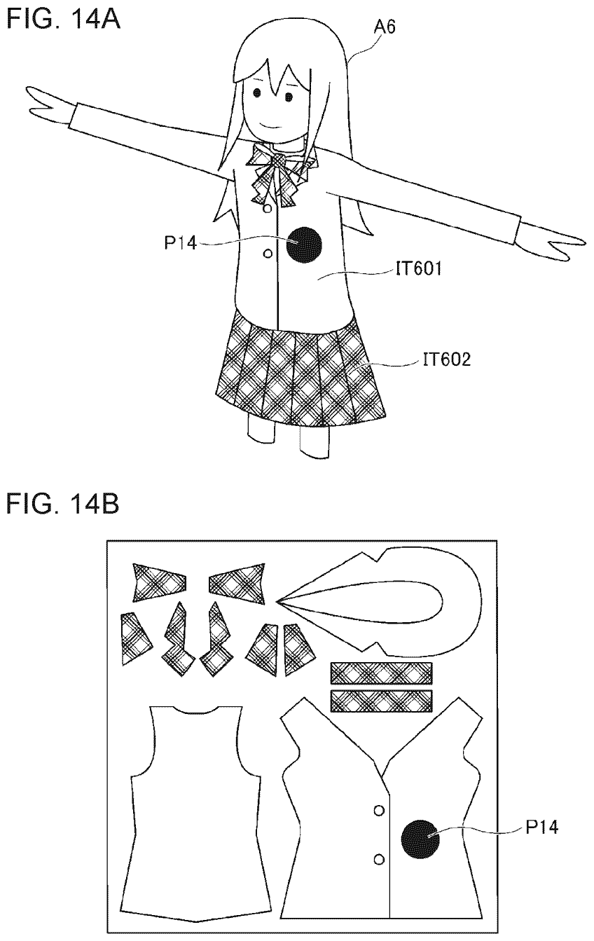

For example, in the example shown in FIG. 14, clothes and decorations that can be worn on an avatar are managed for each paper pattern and part. More specifically, in FIG. 14A, an avatar wearing clothes and decorations is schematically shown, and FIG. 14B schematically illustrates paper patterns and parts for forming (drawing) the clothes and decorations. Note that drawing of each paper pattern may be realized using a stencil buffer or the like. The arrangement of the image on the pattern may be adjustable by adjusting the positions on the two axes of the UV coordinate system. By performing the rendering of a specific image via a corresponding pattern for one three-dimensional item, it is possible to reduce the processing load compared to directly applying the specific image onto the surface of a three-dimensional item.

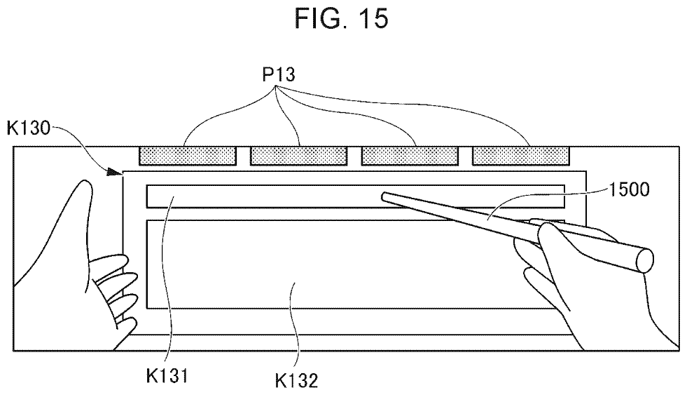

FIG. 15 schematically shows an example of a manipulator 1500 that can be used in the metaverse space. In this example, the manipulator 1500 has a form similar to that of a laser pointer, and can activate or select the UI at the position pointed to by the pointer. For example, in FIG. 14, the point selected by the manipulator 1500 is schematically indicated by a point P14. In this case, the user may move the point P14 onto a part of a desired item and perform an operation on this part. FIG. 15 illustrates an example of a manner in which the manipulator 1500 is operated by the user on the UI 13 shown in FIG. 13A. Note that the manipulator 1500 may move according to an input that is given via an input device (such as a controller) held by the user (wearing a head-mounted display) in the real world.

In the example shown in FIG. 15, an input is given using the manipulator 1500, but as described above, various input methods are possible, such as voice input to indicate a part or the like, or input of keywords instead of characters.

Note that the various UIs shown in FIGS. 13A to 13C are merely examples, and can be modified in various ways. UIs other than the UIs shown in FIGS. 13A to 13C may be used. For example, a UI may be provided for setting physical parameters of the item (for example, stiffness, gravity, resistance, collision radius, and/or the like). The gravity and resistance are parameters that may be associated with an item such as the avatar's hair, clothes, or the like, and may affect the dynamic behavior (such as shaking) of the hair, clothes, or the like. The collision radius is a parameter that defines the distance at which collision (interference) with another item in the virtual space occurs. Default values for these parameters may be automatically prepared for each item attribute by artificial intelligence.

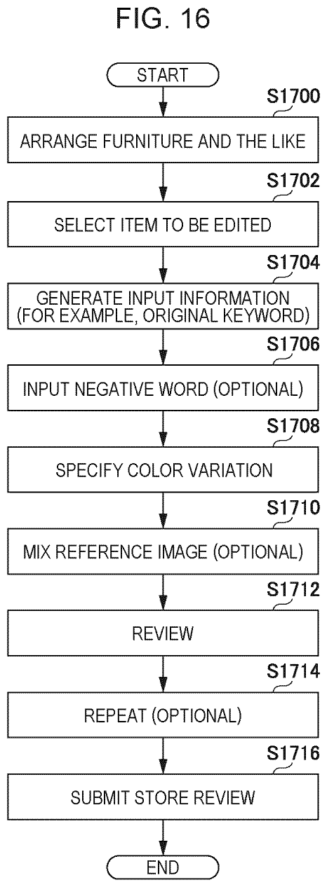

Further functions that may be realized in the system 1 are described below with reference to FIG. 16.

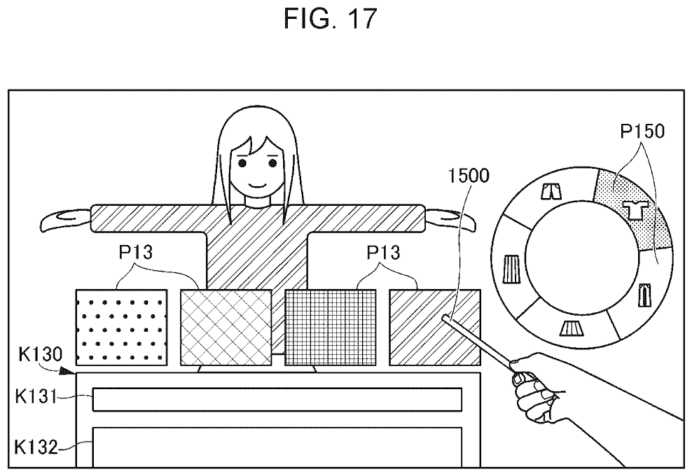

FIG. 16 is a flowchart showing an example of an outline of a user-side operation procedure that can be realized in the system 1. FIG. 17 is an explanatory diagram of the procedure shown in FIG. 16, and shows a screen used by the user to edits clothes of the avatar. Note that the screen shown in FIG. 17 may be a screen of a display unit 23, in the form of a head-mounted display, of the terminal device 20.

FIG. 16 shows an example of an operation procedure for arranging items IT800 and IT801 such as furniture in the virtual space as shown in FIG. 8 and editing the arranged items and items IT601 and IT602 of a user's avatar A6. Various functions based on the operation procedures described below can be realized by the user, for example, via the input unit 24 of the terminal device 20.

In step S1700, the user arranges items such as furniture in the virtual space. Note that the virtual space in which items can be placed by one user may be any space, but an example is a space on an area (a land) in a virtual space owned by the one user. The items that can be placed in the virtual space may be items owned by the user.

In step S1702, the user selects an item or a part of an item to be edited from the various items in the virtual space. This selection may be performed, for example, via the UI shown in FIG. 13C.

In step S1704, the user generates input information. The input information is as described above, and an example of the input information may be an original keyword or the like. Note that the generation of the input information may be performed, for example, via the UI 13 shown in FIG. 13A.

In step S1706, the user inputs a negative word as part of the input information. The negative words are as described above. Note that the operation in step S1706 may be omitted as appropriate.

When step S1704 (and step S1706) is completed in the manner described above, a specific image corresponding to the input information is generated as described above with reference to FIGS. 4A and 4B. The specific image generated in this manner may be reflected on the part selected in step S1702 on the preview display. That is, the part selected in step S1702 may be rendered so as to include the generated specific image.

In step S1708, the user specifies a color variation for the specific image. Note that the specifying of the color variation for the specific image may be performed, for example, via the UI 14 shown in FIG. 13B.

In step S1710, the user modifies the specific image by mixing a reference image with the specific image on the preview display. The reference image may be displayed, for example, in one of the specific image display areas P13 of the UI 13 shown in FIG. 13A, and may be specified by the user by selecting the specific image display area P13 including the reference image to be mixed. Note that the reference image may be an image prepared in advance for mixing, or may be another specific image generated based on other input information as described above. Note that the operation in step S1710 is optional and may be omitted as appropriate.

In step S1712, the user reviews the item or the part of the item being edited on which the specific image obtained in the above-described manner is reflected wherein the reviewing is performed three-dimensionally while performing panning and/or rotating.

In step S1714, the user repeats editing while changing the item or the part in the item being edited. For example, as shown in FIG. 17, in a state in which various UIs 13, 14, and 15 such as those shown in FIGS. 13A to 13C, the user may perform various operations using the manipulator 1500 such as that shown in FIG. 15.

In step S1716, when the user obtains an item on which the specific image is satisfactorily reflected, the user submits a store review application. The store review application is accepted by the server device 10, and processed in a manner that will be described later.

Note that the editing of the specific image is described above with reference to FIG. 16, but the item shape and the item texture described above may also be edited in a similar manner. After the editing of the item shape or the item texture is completed, the user may apply for store review. The store review application may be submitted on an item-by-item basis.

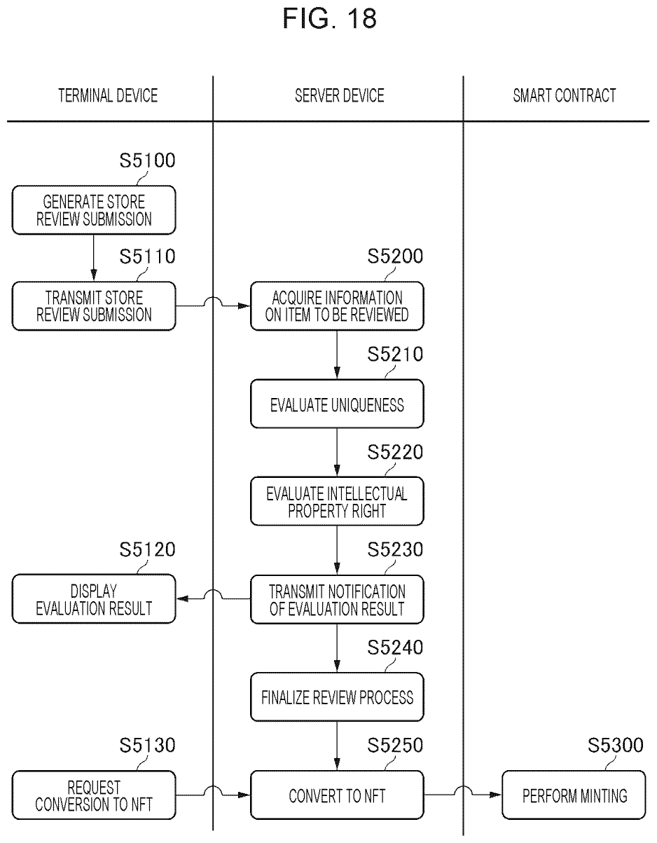

FIG. 18 is a flowchart of processing that may be performed by the server device 10 upon receiving the store review application. In FIG. 18, the processing is shown separately for the server device 10, the terminal device 20, and a smart contract (a blockchain network 5).

The user generates a store review application via the terminal device 20 (in step S5100) and transmits it to the server device 10 (in step S5110). The store review application may include information identifying the item for which the store review is to be performed.

Upon receiving the store review application, the server device 10 acquires information on the item for which the store review is to be performed (step S5200). The information on the item for which the store review is to be performed may include the item to be reviewed, the specific image associated with the item to be reviewed, the item shape applied to the item to be reviewed, and the item texture associated with the item to be reviewed.

The server device 10 evaluates the uniqueness of the item being reviewed based on the acquired information on the item being reviewed (step S5210). The uniqueness is a parameter that correlates with originality. Note that equivalently, instead of evaluating the uniqueness, similarity to other items may be evaluated. This is because high/low uniqueness corresponds to low/high similarity. Therefore, in the following description, the uniqueness can be read as similarity, where a high uniqueness state corresponds to a low similarity state, and a low uniqueness state corresponds to a high similarity state.

The uniqueness evaluation method is as follows. In a case where the item to be reviewed includes a specific image generated based on the input information, the uniqueness may be evaluated based on the similarity in appearance and/or the like between the specific image and other images. In this case, in the evaluation of the uniqueness, the input information (the input information input to the image output model) used to generate the specific image may be taken into account. For example, in a case where the input information used to generate one specific image is similar to the input information used to generate another image, the uniqueness of this one specific image may be calculated as a low value. In this case, the uniqueness can be calculated based on the comparison between the pieces of input information, and therefore the reliability of the calculation result can be enhanced while reducing the processing load. Word embedding in natural language processing, such as Word2vec, may be used to compare the input information. In the case of Word2vec, when word vectors of characters (words) included in the input information are located close to each other in the vector space, these word vectors are determined to have a high degree of similarity. By using such natural language processing, it is possible to efficiently evaluate the similarity between pieces of input information. It is possible to efficiently evaluate the similarity between pieces of input information also for various kinds of languages. It is also possible to make comparisons in latent space like the Diffusion Model, or based on word edit distance or Euclidean distance in CLIP (Contrastive Language-Image Pre-training) that may be used internally.

The server device 10 may further evaluate the intellectual property right based on the acquired information on the item being reviewed (in step S5220). The evaluation on the intellectual property right may be performed in terms of whether the appearance of the item being reviewed clearly infringes design rights or the like of others. The evaluation on the intellectual property right may be performed in terms of whether the item being reviewed includes a trademark pertaining to a trademark right of others. An evaluation (check) may be performed from the viewpoint of whether or not the appearance of the item being reviewed is clearly offensive to public order or morality.

The server device 10 outputs a notification of the uniqueness evaluation result (in step S5230). The notification of the uniqueness evaluation result may be displayed on the terminal device 20 (in step S5120). It is not necessarily needed to make a notification of the result of the evaluation of the intellectual property rights, but if there is a clear infringement of the rights of others or there is a high likelihood of infringement, a notification of this fact may be given. The same applies to cases that are clearly offensive to public order or morality, or cases where there is a high probability of such offences. The application may be rejected if it clearly violates the right of others or is highly likely to do so, and/or if it is clearly contrary to public order or morality or is highly likely to do so.

The server device 10 performs an application completion process by storing the reviewed item in a specified database or the like (in step S5240). The item stored in this manner may be used in evaluating the uniqueness of another item requested to be reviewed (in step S5210). When the application completion process ends, the terminal device 20 may be notified of this fact.

After that, when the user requests the item, which has been subjected to the application completion process, to be converted to NFT (in step S5130), the server device 10 executes an NFT conversion process (in step S5250). The NFT conversion process includes issuing the item of interest as an NFT (Non-Fungible Token). In this process, the server device 10 may perform minting via a smart contract on a blockchain network 5 (in step S5300). Note that the NFT conversion process may further include listing the issued NFTs on a marketplace or the like.

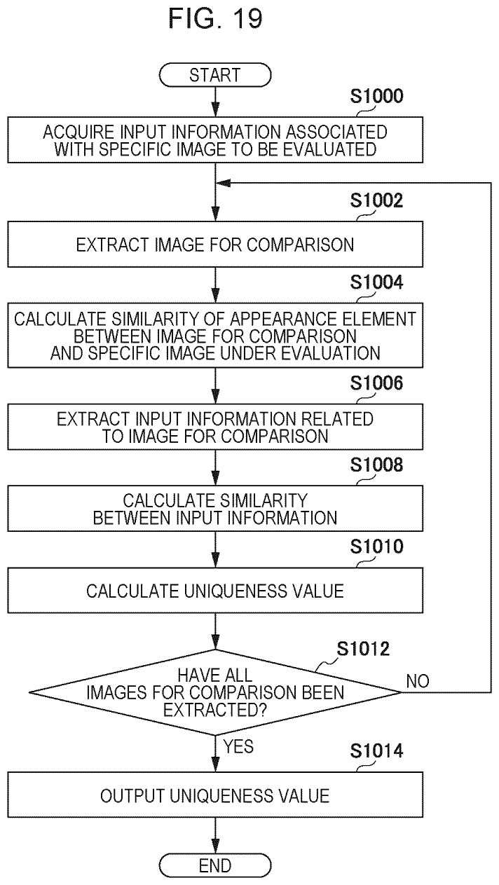

FIG. 19 is a flowchart illustrating an outline of an example of a uniqueness evaluation process.

In step S1000, the server device 10 acquires (extracts) input information associated with the specific image based on the specific image information of the specific image to be evaluated.

In step S1002, the server device 10 extracts a comparative image to be compared with the specific image. Comparative images to be used in the comparison may be accumulated in a predetermined database. The comparative images may be extracted on a one-by-one basis. In step S1004, the server device 10 calculates the similarity of appearance elements between the specific image under evaluation and the comparative image. The appearance elements may include, for example, at least one of a color, a texture, and a pattern. The appearance elements may also include other elements such as a composition (an arrangement). The method of calculating the similarity of the appearance elements may include, for example, the similarity may be calculated as a score. For example, images of an avatar wearing clothes may be captured while rotating it over an azimuth angle range of 360 degrees and/or over an elevation angle range of 90 degrees, and a numeric value indicating the similarity (in terms of color/shape) of the captured images may be calculated and evaluated.

In step S1006, the server device 10 acquires (extracts) input information related to the comparative image used in comparison. The input information related to the comparative image used in comparison is the input information used to generate that comparative image and is input into the image output model. Such input information may be stored in a predetermined database in association with the image for comparison. Note that, in the present embodiment, the comparative images used in the comparison may be limited to only images that are associated with input information.

In step S1008, the server device 10 calculates the similarity between the input information related to the specific image under evaluation and the input information related to the comparative image used in the comparison. The similarity between different pieces of input information may be calculated using Word2vec as described above. This is because when the different pieces of the input information input to the image output model include the same or similar characters, similar specific images are likely to be generated for these different pieces of the input information.

In some cases, depending on the image output model used, the input information input to the image output model includes a seed value of a random number in order to ensure the uniqueness of the generated specific image. In this case, when the seed values of the random numbers included in the different pieces of input information input to the image output model are the same, the generated specific images are likely to be similar. Therefore, from the above point of view, the server device 10 may further calculate the similarity between the different pieces of input information based on the relationship between the seed values of the random numbers.

In step S1010, the server device 10 calculates a uniqueness value based on the similarity between appearance elements calculated in step S1004 and the similarity between the pieces of input information calculated in step S1008. The calculation of the uniqueness value may be performed using only either one of the similarity of the appearance elements calculated in step S1004 or the similarity of the input information calculated in step S1008 (for example, the one with the higher similarity). Alternatively, the calculation of the uniqueness value may be performed using the averages or the combinations.

In step S1012, the server device 10 determines whether or not all comparative images for comparison have been extracted. That is, it is determined whether or not the evaluation of the uniqueness of the specific image under the evaluation is completed for all comparative images. In a case where the determination result is “YES”, the process proceeds to step S1014, but otherwise, the process returns to step S1002 to extract a new comparative image for comparison, and the process is repeated from step S1004.

In step S1014, the server device 10 outputs a uniqueness value based on the uniqueness evaluation result for the specific image under evaluation with respect to all comparative images. Note that the uniqueness value may be output separately for each comparative image used for comparison, or only a specific value such as the minimum value (the uniqueness value for the most similar comparative image) may be output.

In the example shown in FIG. 19, the uniqueness of the specific image under evaluation is evaluated based on both the similarity of appearance elements and the similarity of input information, it is possible to obtain high reliability of the evaluation result compared to the case where the evaluation is performed based on either one of these. However, alternatively, the uniqueness of the specific image under evaluation may be evaluated based on only one of the similarity of appearance elements and the similarity of input information.

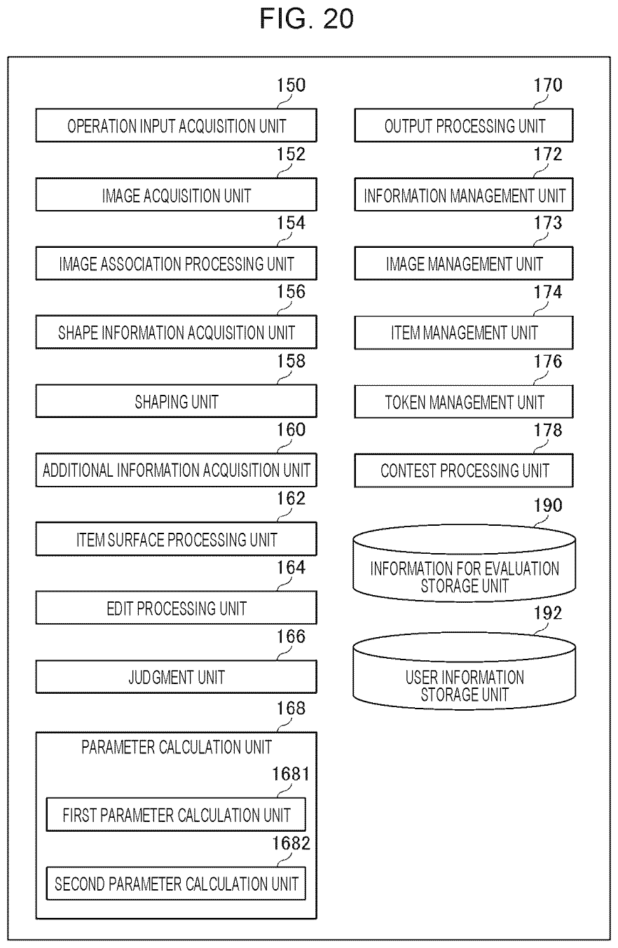

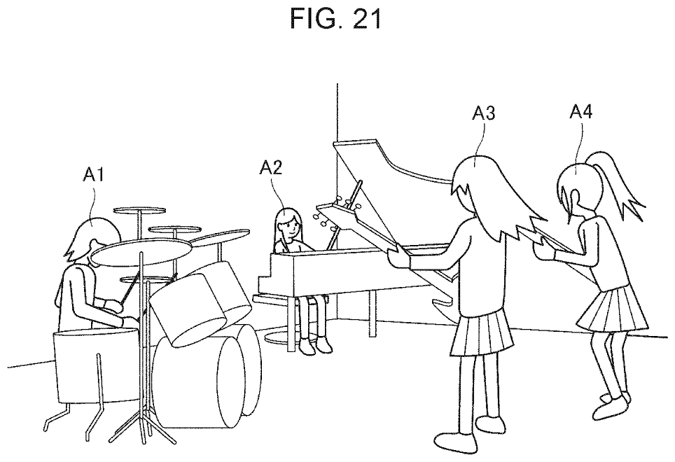

Next, an example of a set of functions of the server device 10 in the system 1 is described with reference to FIG. 20 and the following figures.

In the following description, the functions of the server device 10 will be mainly described. Part or all of the functions of the server device 10 described below may be realized by one or more terminal devices 20.

FIG. 20 is a block diagram schematically showing an example of the set of functions of the server device 10.

In the example shown in FIG. 20, the server device 10 includes an operation input acquisition unit 150, an image acquisition unit 152, an image association processing unit 154, a shape information acquisition unit 156, a shaping unit 158, an additional information acquisition unit 160, an item surface processing unit 162, an edit processing unit 164, a judgment unit 166, a parameter calculation unit 168, an output processing unit 170, an information management unit 172, an image management unit 173, an item management unit 174, a token management unit 176, a contest processing unit 178, an information for evaluation storage unit 190, and a user information storage unit 192. Each processing unit such as the operation input acquisition unit 150 can be realized by the server communication unit 11 or the server control unit 13 shown in FIG. 1. Storage units such as the information for evaluation storage unit 190, the user information storage unit 192, and the like can be realized by the server storage unit 12 shown in FIG. 1.

The operation input acquisition unit 150 acquires various user inputs given by each user via the input unit 24 of the terminal device 20. The various inputs are as described above.

The image acquisition unit 152 acquires a specific image based on input information given by a user. The method of acquiring the specific image may be as described above with reference to step S2200 shown in FIG. 3.

The image association processing unit 154 associates a specific image with a specific item available in a virtual space. The specific item is as described above. The method of associating the specific image may be as described above with reference to step S2240 shown in FIG. 3.

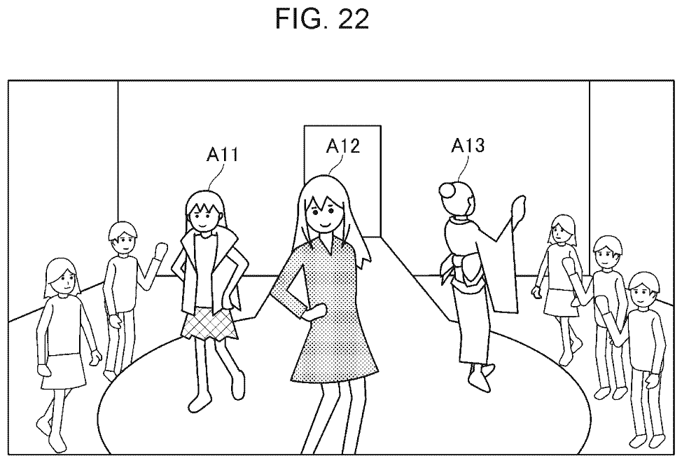

The image association processing unit 154 may simultaneously associate the acquired specific image or a derivative image obtained by changing a part of the specific image with specific items related to a plurality of avatars. The derivative image obtained by changing a part of the specific image may be an image that is not exactly the same as the original specific image, but has a common feature or features that can produce a sense of unity in combination, etc. In this case, it is possible to associate, at once, the specific image and the like with specific items of a plurality of avatars having a specific relationship, which results in a reduction in the processing load compared to the case where similar specific images are obtained separately and associated with the specific items. FIG. 21 schematically shows four avatars A1 to A4 performing in a band. The image association processing unit 154 may simultaneously associate a specific image or a derivative image obtained by changing a part of the specific image with such a plurality of companion avatars. In this case, an association instruction (see step S3130 in FIG. 9) may be generated by any one or more users among the users of the plurality of avatars. Alternatively, based on the association instructions issued from all users (see step S3130 in FIG. 9), an association instruction may be generated for simultaneously associating a specific image with specific items related to a plurality of avatars.

Note that the specific relationship described above may include a relationship in which a plurality of avatars are all associated with one user (that is, one user is associated with avatars of a group). The specific relationship described above may include, instead of or additionally to the relationship described above, a relationship in which one user and one avatar are associated with each other and a plurality of users are associated with each other (for example, users have a friendship relationship).

The shape information acquisition unit 156 acquires an item shape (an example of shape information) based on the input information given by the user. The method of acquiring the item shape may be as described above with reference to step S4200 in FIG. 11.

The shaping unit 158 shapes the specific item based on the item shape. The method of shaping the specific item may be as described above with reference to step S4240 shown in FIG. 11.

As with the image association processing unit 154, the shaping unit 158 may simultaneously shape specific items related to a plurality of avatars based on an acquired item shape or a derivative item shape obtained by partially changing the item shape. In this case, it is possible to simultaneously shape specific items of a plurality of avatars having a specific relationship such as a friendship relationship, which results in a reduction in the processing load compared to the case where similar item shapes are obtained separately and specific items are shaped separately.

The additional information acquisition unit 160 acquires item surface information that can be reflected on the surface (the appearance) of the specific item based on the input information given by the user. The item surface information may be information for setting or changing at least one of a pattern, a fabric, a decoration, and a texture of the specific item. The method of acquiring the item texture may be as described above with reference to step S3200 in FIG. 9. Other item surface information may also be acquired by a similar method. In a case where a plurality of pieces of item surface information are acquired, they may be acquired at the same time or separately.

The item surface processing unit 162 sets or changes at least one of the pattern, the fabric, the decoration, and the texture of the specific item based on the item surface information. The method of setting or changing the texture of the specific item based on the item texture may be as described above with reference to step S4240 in FIG. 11. Other item surface information may also be acquired by a similar method.

As with the image association processing unit 154, based on the acquired item surface information or the derivative item shape obtained by partially changing the item surface information, the item surface processing unit 162 may simultaneously set or change at least one of patterns, fabrics, decorations, and textures of specific items related to a plurality of avatars. In this case, it is possible to associate, at once, the specific image and the like with specific items of a plurality of avatars having a specific relationship such as a friendship relationship, which results in a reduction in the processing load compared to the case where similar item surface information is obtained separately and setting or change is performed.

The edit processing unit 164 edits the item shape based on information on the avatar to be associated with the specific item and information on the space in which the specific item is to be placed. For example, in a case where the size of the avatar that matches the item shape is larger or smaller than the size of the avatar to be shaped, the edit processing unit 164 may similarly change the item shape according to the size difference. In a case where the size of the space in which the specific item (for example, a dresser) is to be placed is larger or smaller than the size of the space in which the item to be shaped is placed, the edit processing unit 164 may change the item shape according to the size difference. This makes it possible to increase the versatility of the item shape, and as a result, it is possible to reduce the processing load (for example, the processing load required for obtaining an item shape for each size difference).

The edit processing unit 164 edits the item surface information based on the information on the avatar to be associated with the specific item. For example, in a case where the size of an avatar that matches the decoration related to the item surface information is larger or smaller than the size of the avatar to be associated with the specific item, the edit processing unit 164 may similarly change the decoration related to the item surface information according to the size difference. This makes it possible to increase the versatility of the item surface information, and as a result, it is possible to reduce the processing load (for example, the processing load required for obtaining item surface information for each size difference).

In this case, the edit processing unit 164 may evaluate a corresponding 3D model of an avatar for editing purpose based on a common standard for 3D avatars, such as VRM. In this case, it is possible to obtain a specific item (and an avatar associated with the specific item) that can be used on a plurality of avatar platforms (in various services).

The judgment unit 166 determines whether the input information given by the user satisfies a predetermined condition. The predetermined condition may be set from various viewpoints. For example, the predetermined condition may include that the input information includes a predetermined prohibited word. The predetermined prohibited word may be as described above. The predetermined condition may be satisfied when the possibility of infringing another person's intellectual property right is equal to or higher than a predetermined threshold value or when the possibility of violating public order or morality is equal to or higher than a predetermined threshold value. Note that the predetermined condition may be appropriately set by an operator of the present service.

The parameter calculation unit 168 calculates the values of parameters related to similarities such as the uniqueness values described above (examples of specific parameters), such as similarity between specific items, similarity between specific images, similarity between item shapes, and similarity between item textures. Note that the similarity between different specific items may be evaluated in a state in which any one of the specific image, the item shape, and the item texture is reflected.

Parameters related to various types of similarity and methods for calculating the values thereof may be as described above with reference to FIG. 19.

In the present embodiment, the parameter calculation unit 168 includes a first parameter calculation unit 1681 and a second parameter calculation unit 1682.

The first parameter calculation unit 1681 calculates the similarity of appearance elements between a specific image under evaluation and a comparative image. The method of calculating the similarity between appearance elements may be, for example, as described above with reference to step S1004 in FIG. 19.

The first parameter calculation unit 1681 may calculate the similarity of the appearance elements based on the attributes of specific items with which the specific images are associated. The first parameter calculation unit 1681 may calculate the similarity of the appearance elements based on a relationship between an attribute of an item associated with a comparative image and an attribute of a specific item associated with a specific image. In this case, the first parameter calculation unit 1681 may calculate the similarity of the appearance elements such that when the attributes are the same or similar to each other or have common features, the similarity of the appearance elements is calculated to be high compared to the opposite case.

The first parameter calculation unit 1681 may change the method of calculating similarity of appearance elements according to the attribute of the specific item with which the specific image is associated. For example, in a case where specific items associated with specific images are three-dimensional items, the first parameter calculation unit 1681 may calculate the similarity of appearance elements based on three-dimensional views seen from a plurality of viewpoints. For example, in a case where specific items associated with specific images are not three-dimensional items, if the items are those of avatars, the first parameter calculation unit 1681 may calculate the similarity of appearance elements based on three-dimensional views of avatars wearing the items seen from a plurality of viewpoints.

The second parameter calculation unit 1682 calculates similarity between different pieces of input information. The method of calculating the similarity between the different pieces of input information may be, for example, as described above with reference to step S1008 in FIG. 19.

In this case, the value calculated by the first parameter calculation unit 1681 and the value calculated by the second parameter calculation unit 1682 may be used in combination as described above with reference to FIG. 19.

The output processing unit 170 outputs the value of the parameter related to similarity calculated by the parameter calculation unit 168. The method of outputting the value of the parameter related to similarity may be output, for example, for processing by the item management unit 174 or the like, which will be described later. Alternatively, the outputting of the value of the parameter related to similarity may be realized by notifying the owner or the like of the specific item under evaluation.

The information management unit 172 manages (stores, extracts, etc.) specific images and the like in association with input information. More specifically, the information management unit 172 may generate and manage the specific image information described above with reference to FIG. 3 (step S2210). Furthermore, the information management unit 172 may generate and manage the item texture information described above with reference to FIG. 9 (step S3210), the item shape information described above with reference to FIG. 11 (step S4210), and/or the like. As described above, various types of information generated and managed by the information management unit 172 can be suitably used for calculation of parameters related to various similarities by the parameter calculation unit 168.

In a case where the determination result by the judgment unit 166 indicates that the input information satisfies the predetermined condition, the image management unit 173 prohibits or restricts the use or distribution in the virtual space of the specific image acquired based on this input information. As described above, the predetermined condition can be determined, for example, by the operator of the virtual space. This makes it possible to appropriately prevent a situation where specific images are disorderly associated with items usable in the virtual space. Note that the distribution in the virtual space may include sales or the like on the market in the virtual space.

The item management unit 174 permits, prohibits, or restricts use or distribution in the virtual space for each specific item based on the value of the specific parameter calculated by the parameter calculation unit 168. For example, in a case where a specific image is associated with a specific item by the image association processing unit 154, the item management unit 174 permits, prohibits, or restricts use or distribution in the virtual space of the specific item in a state in which the specific image is associated with the specific item, based on the value of the specific parameter calculated by the parameter calculation unit 168. Similarly, in a case where a specific item is shaped by the shaping unit 158, the item management unit 174 permits, prohibits, or restricts use or distribution in the virtual space of the specific item in the shaped state, based on the value of the specific parameter calculated by the parameter calculation unit 168. Similarly, in a case where item surface information is associated with a specific item by the item surface processing unit 162, the item management unit 174 permits, prohibits, or restricts the use or distribution in the virtual space of the specific item in the state where the item surface information is associated, based on the value of the specific parameter calculated by the parameter calculation unit 168.

Furthermore, like the image management unit 173, in a case where the determination result by the judgment unit 166 indicates that input information satisfies the predetermined condition, the item management unit 174 may prohibit or restrict the use or distribution in the virtual space of a specific item with which the specific image acquired based on this input information is associated.

The token management unit 176 issues and manages a token, such as a non-fungible token (NFT), for a specific item. The method of issuing the NFT for a specific item or the like may be as described above with reference to step S5250 FIG. 18. In addition to the management of issuance, the token management unit 176 may record the owner and the transfer of ownership of the token, and may duplicate or discard the token by paid or free application in markets, smart contracts, or distributed processing modules outside the system 1.

As with the image management unit 173, in a case where the determination result by the judgment unit 166 indicates that the input information satisfies the predetermined condition, the token management unit 176 may prohibit or restrict the issuance or distribution of the token based on the specific image acquired based on this input information.

The contest processing unit 178 executes processing related to holding various contests in the virtual space. There is no particular restriction on the various contests, but an example is a contest for specific items such as those described above. FIG. 22 is a diagram conceptually illustrating a manner in which a contest is held. More specifically, FIG. 22 shows a fashion contest in which a plurality of users display specific items on a stage in the virtual space via avatars A11, A12, and A13 wearing specific items with which the above-described specific images are associated.

Evaluation results (for example, voting results) from a plurality of users in the virtual space may be collected for specific items to which specific images are associated by the image association processing unit 154 or for avatars associated with specific items. Furthermore, the contest processing unit 178 may execute various processes, such as announcing the ranking and awarding prizes to the winner, based on the evaluation results. In this case, instead of or in addition to the evaluation results by the plurality of users, artificial intelligence based on given logic may be used. For example, in a contest regarding a specific theme or mission, it may be determined based on artificial intelligence whether the theme is matched or the mission is cleared. More specifically, for example, in the case of a contest on a theme of “cool adults”, parameters such as the maturity, coolness, cuteness, etc., of the specific items worn by avatars may be set, and based on the values of these parameters, the superiority or inferiority may be determined by artificial intelligence. In this case, artificial intelligence may be constructed by learning past evaluation results by humans (for example, highly reliable evaluators or management operators).

The information for evaluation storage unit 190 may store the above-described various information generated and managed by the item management unit 174.

The user information storage unit 192 may store information necessary for realizing the various processes described above for each user (for example, for each user ID). For example, information on a corresponding avatar (for example, a VRM file), information on various specific items owned by users, and the like may be stored on a user-by-user basis.

In the example shown in FIG. 20, the image association processing unit 154, the shaping unit 158, and the item surface processing unit 162 execute processing independently of each other, but this is merely by way of example and not limitation. For example, a combination of any two or more of the image association processing unit 154, the shaping unit 158, and the item surface processing unit 162 may function simultaneously. More specifically, for example, the image association processing unit 154 and the shaping unit 158 may simultaneously function to generate a specific item in which the item shape and/or the specific image obtained as described above are both reflected.

Although the present disclosure has been described in detail with reference various embodiments, the disclosure is not limited to any specific embodiment, and various modifications and changes are possible within the scope described in the claims. It is also possible to combine all or some of the constituent elements of one or more of the embodiments.

For example, in the above-described embodiments, a specific image, an item shape, and an item texture are obtained independently of each other, but this is merely by way of example and not limitation. For example, a combination of any two or more of the specific image, the item shape, and the item texture may be acquired at the same time. In this case, the machine learning model may also be constructed in an integrated manner.

The following additional notes are disclosed regarding the above embodiments.

Note 1. An information processing system may include a user input acquisition unit configured to acquire an input given by a user, an image acquisition unit configured to acquire, using a first machine learning model constructed by artificial intelligence, a specific image obtained by inputting the given input to the first machine learning model, and an association processing unit configured to associate the specific image with a specific item usable in a virtual space.

Note 2. In the information processing system described in Note 1, the specific item may be rendered visible in the virtual space by reflecting the specific image on a corresponding paper pattern, wherein the information processing system may further include a paper pattern generation unit configured to generate the paper pattern using a machine learning model constructed by artificial intelligence.

What is claimed is:

1. An information processing system, comprising:
processing circuitry configured to
acquire an input given by a user;
acquire, using a machine learning model constructed by artificial intelligence, a specific image obtained by inputting the given input to the first machine learning model; and
associate the specific image with a specific item usable in a virtual space.

2. The information processing system according to claim 1, wherein the specific item includes at least one of an item associated with an avatar in the virtual space and an item placed in the virtual space.

3. The information processing system according to claim 1, wherein the processing circuitry is further configured to
acquire, using a machine learning model constructed by artificial intelligence, shape information of the specific item obtained by inputting the given input to the second machine learning model, and
shape the specific item based on the shape information.

4. The information processing system according to claim 1, wherein the processing circuitry is further configured to
acquire, using a machine learning model constructed by artificial intelligence, item surface information obtained by inputting the given input to the third machine learning model, and
set or change at least one of a pattern, a fabric, a decoration, and a texture of the specific item based on the item surface information.

5. The information processing system according to claim 3, wherein
the specific item includes at least one of an item associated with an avatar in the virtual space and an item placed in the virtual space, and
the processing circuitry is further configured to edit the shape information based on information on the avatar to be associated with the specific item or information on the space in which the specific item is to be placed.

6. The information processing system according to claim 4, wherein
the specific item includes an item associated with an avatar in the virtual space, and
the processing circuitry is further configured to edit the item surface information based on information on the avatar with which the specific item is to be associated.

7. The information processing system according to claim 1, wherein the given input includes at least one of a text, a symbol, a pictogram, a digit figure, a color, a texture, an image, a sound, a gesture, and a combination of any two or more of these.

8. The information processing system according to claim 1, wherein the processing circuitry is further configured to collect evaluation results from a plurality of users in the virtual space with respect to the specific item with which the specific image is associated, or an avatar with which the specific item is associated.

9. The information processing system according to claim 1, wherein the processing circuitry simultaneously associates the specific image or a derivative image obtained by changing a part of the specific image with the specific items related to a plurality of avatars.

10. The information processing system according to claim 1, wherein the processing circuitry is further configured to
calculate a value of a specific parameter related to similarity between the specific item with which the specific image is associated and another item that is usable in the virtual space, and
output the value of the specific parameter.

11. The information processing system according to claim 10, wherein the processing circuitry calculates the value of the specific parameter related to the one specific item with which the specific image is associated, based on the specific image associated with the one specific item and the given input used to acquire the specific image.

12. The information processing system according to claim 11, wherein the processing circuitry calculates the value of the specific parameter related to the one specific item with which the specific image is associated further based on an attribute of the one specific item.

13. The information processing system according to claim 11, wherein
the processing circuitry is further configured to calculate a value of a first parameter related to similarity between the specific image and an image associated with the other item, and
the value of the specific parameter includes the value of the first parameter or a value based on the value of the first parameter.

14. The information processing system according to claim 13, wherein the processing circuitry calculates the value of the first parameter based on at least one of a color, a texture, and a pattern.

15. The information processing system according to claim 13, wherein the processing circuitry calculates the value of the first parameter based on three-dimensional views seen from a plurality of viewpoints.

16. The information processing system according to claim 10, wherein
the processing circuitry is further configured to calculate a value of a second parameter related to similarity between the given input used to acquire the specific image and another input corresponding to the given input and used to generate an image associated with the other item, and
the value of the specific parameter includes the value of the second parameter or a value based on the value of the second parameter.

17. The information processing system according to claim 16, wherein the processing circuitry calculates the value of the second parameter based on a relationship between a text included in the given input and a text included in the other input.

18. The information processing system according to claim 16, wherein
the given input and the other input each further include a random seed value, and
the processing circuitry calculates the value of the second parameter based on a relationship between the seed value included in the given input and the seed value included in the other input.

19. The information processing system according to claim 10, wherein the processing circuitry is further configured to permit, prohibit, or restrict use or distribution in the virtual space of the specific item with which the specific image, based on the value of the specific parameter.

20. The information processing system according to claim 1, wherein the processing circuitry is further configured to manage, in association with the given input, the specific image or the specific item with which the specific image is associated.

21. The information processing system according to claim 1, wherein the processing circuitry is further configured to
determine whether the given input satisfies a predetermined condition, and
in a case where the given input satisfies the predetermined condition, prohibit or restrict use or distribution in the virtual space of the specific image acquired based on the given input.

22. The information processing system according to claim 21, wherein the predetermined condition is satisfied when a possibility of infringing another person's intellectual property right is equal to or higher than a predetermined threshold value or when a possibility of violating public order or morality is equal to or higher than a predetermined threshold value.

23. The information processing system according to claim 1, wherein the processing circuitry is further configured to issue and manage a non-fungible token based on the specific image or the specific item with which the specific image is associated.

24. An information processing method, comprising:
acquiring an input given by a user;
acquiring, using a machine learning model constructed by artificial intelligence, a specific image obtained by inputting the given input to the machine learning model; and
associating the specific image with a specific item usable in a virtual space.

25. A non-transitory computer readable medium storing computer executable instructions which, when executed by a computer, cause the computer to:
acquire an input given by a user;
acquire, using a machine learning model constructed by artificial intelligence, a specific image obtained by inputting the given input to the machine learning model; and
associate the specific image with a specific item usable in a virtual space.
